(19) United States
(12) Patent Application Publication
(10) Pub. No.: US 2008/0230148 A1
(43) Pub. Date: Sep. 25, 2008

(54) SPEED READINESS INDICATOR FOR A SAW HEAD IN A TREE FELLER

(76) Inventor: Van E. Waggoner, Dubuque, IA (US)

Correspondence Address: TAYLOR & AUST, P.C., P.O. Box 560, 142. S Main Street, Avilla, IN, 46710, US

(21) Appl. No.: 11/688,956

(22) Filed: Mar. 21, 2007

(51) Int. Cl. B27C 9/00

(52) U.S. Cl. 144/23

(57) ABSTRACT

A forestry machine includes a frame; a felling saw carried by the frame; and a speed readiness indicator associated with a saw head of the felling saw. The speed readiness indicator includes at least one sensor, a visual indicator and a controller. The one or more sensors provide an indication of a rotational speed of the saw head. The controller is coupled with each sensor and the visual indicator. The controller receives an input signal from each sensor and actuates the visual indicator to indicate an approximate rotational speed of the saw head.

### FIELD OF THE INVENTION

The present invention relates to forestry machinery, and, more particularly, to an indicator for indicating a rotational speed of a felling saw in a tree feller.

### BACKGROUND OF THE INVENTION

Forestry machines in the form of feller bunchers have a saw head at the front end of the machine with a spinning disk at the bottom of the saw head. A plurality of cutting teeth are mounted to the periphery of the spinning disk at spaced apart intervals. The disk is massive and acts as a flywheel which is spun up to operating speed by a hydraulic pump and motor circuit. The saw cuts trees by kinetic energy, not hydraulic power. Thus, rotational speed of the disk is needed and recovery of rotational speed is important to the ability to cut the next tree. Cutting pulls down the speed of the saw by using energy. The longer the operator must wait for the saw to return to operating speed, the less productive the felling operation.

Feller bunchers typically indicate speed of the saw by measuring the pressure change of the hydraulic fluid on a mechanical gauge; that is, high pressure indicates speeding up and lowering pressure indicates steady state operating speed or a “ready to cut” condition. These type gauges are somewhat vulnerable to damage, can leak, and may be difficult to see. A tachometer may also be used, but is likewise hard to see and interpret.

What is needed in the art is a feller buncher with an indicator which provides an easily observable and easy to interpret indication that a saw is in a ready to cut condition within an operating speed range.

### SUMMARY OF THE INVENTION

The invention in one form is directed to a speed readiness indicator for a felling saw in a forestry machine, including at least one sensor, a visual indicator and a controller. The one or more sensors provide an indication of a rotational speed of a saw head. The controller is coupled with each sensor and the visual indicator. The controller receives an input signal from each sensor and actuates the visual indicator to indicate an approximate rotational speed of the saw head.

The invention in another form is directed to a forestry machine, including a frame; a felling saw carried by the frame; and a speed readiness indicator associated with a saw head of the felling saw. The speed readiness indicator includes at least one sensor, a visual indicator and a controller. The one or more sensors provide an indication of a rotational speed of the saw head. The controller is coupled with each sensor and the visual indicator. The controller receives an input signal from each sensor and actuates the visual indicator to indicate an approximate rotational speed of the saw head.

### BRIEF DESCRIPTION OF THE DRAWINGS

FIG. 1 is a front, perspective view of a forestry machine including an embodiment of a speed readiness indicator of the present invention;

FIG. 2 is a schematic view of an embodiment of the speed readiness indicator of the present invention;

FIG. 3 illustrates one embodiment of the visual indicator used in the speed readiness indicator of FIG. 2; and

FIG. 4 illustrates another embodiment of a visual indicator of the present invention.

### DETAILED DESCRIPTION OF THE INVENTION

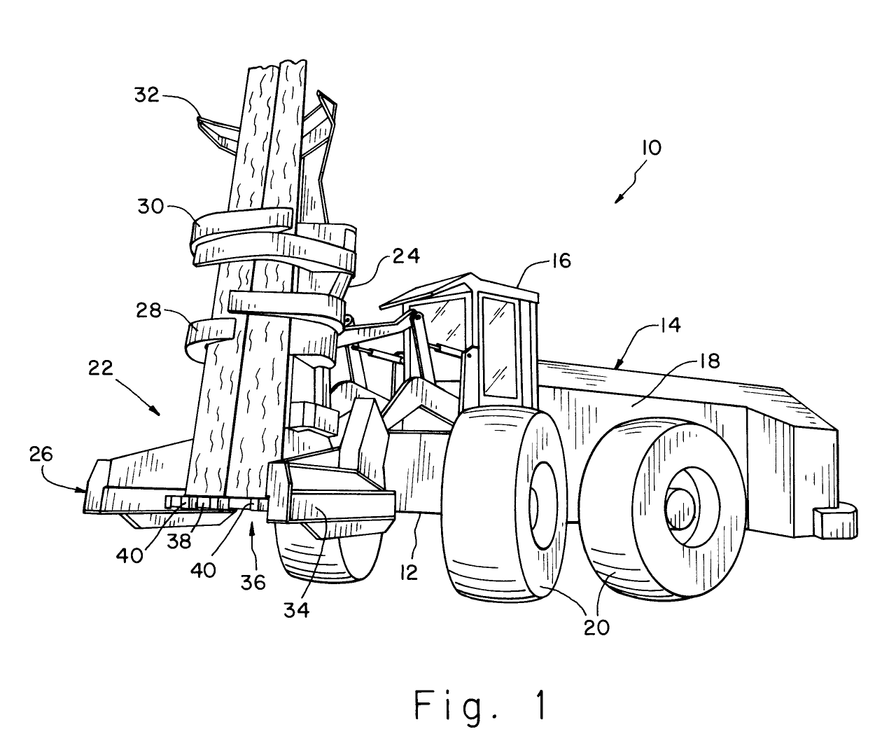

Referring now to the drawings, and more particularly to FIG. 1, there is shown an embodiment of a forestry machine 10 of the present invention. In the embodiment shown, forestry machine 10 is in the form of a Model 643J wheeled feller buncher manufactured by the assignee of the present invention. In general, feller buncher 10 cuts, accumulates and transports to a staging area a number of trees in an area to be harvested. Of course, it will be appreciated that forestry machine 10 can be in the form of a differently configured forestry harvesting machine, such as a different wheeled or track type feller buncher.

In general, feller buncher 10 includes a vehicle frame 12 carrying a body 14, including an operator's station 16 and engine compartment 18. Frame 12 can be variably configured depending upon the application, such as a multi-piece frame for articulated steering (as shown), etc. Wheels 20 are coupled with and supported by frame 12. A felling saw 22 is mounted to the front end of frame 12 and is manipulated using appropriate hydraulic cylinders controlled from within operator's station 16, such as for lifting, tilting, rotating, etc.

Felling saw 22 includes a main beam 24 carrying a saw head 26, accumulator arms 28, gathering arms 30 and horn 32. Accumulator arms 28, gathering arms 30 and horn 32 are of conventional design and not described further herein. Saw head 26 includes a housing 34 and a rotating saw 36. Saw 36 includes a massive rotating disk 38 with a plurality of cutting teeth 40 spaced apart around the periphery thereof for cutting a selected tree. Rotating disk 38 is positioned and rotates below a stationary shelf (not specifically visible in FIG. 1). Teeth 40 extend upwardly around the edge of the stationary shelf so that the trees may be effectively cut and placed upon the shelf. Saw 36 is driven by a hydraulic motor (not shown). During operation, the trees are cut with saw 36 and positioned on top of the non-rotating shelf, and are gathered and accumulated on felling saw 22 using gathering arms 30 and accumulator arms 28.

According to an aspect of the present invention, feller buncher 10 also includes a speed readiness indicator 50 associated with felling saw 22 for indicating a readiness of saw 36 within saw head 26. More particularly, speed readiness indicator 50 indicates a rotational speed of saw 36 within one or more ranges relative to a predetermined operating speed of saw 36. Speed readiness indicator at least indicates a speed readiness of saw 36 within a predetermined range below a maximum operating speed, but may also indicate one or more other speed ranges of saw 36 below the operating speed range.

Referring to FIG. 2, speed readiness indicator 50 includes at least one sensor 52, a visual indicator 54 and a controller 56. In the embodiment shown, speed readiness indicator 50 includes a single sensor 52 which is in the form of a magnetic pick up sensor which provides an output signal to controller 56 representing a rotational speed of saw 36. Other types of sensors providing an output signal representing a rotational speed of saw 36 may also be used, such as optical sensors, etc.

Controller 56 receives the output signals from sensor(s) 52 and provides output signals to visual indicator 54. Controller 56 is typically located within operator's station 16, but may be located elsewhere on feller buncher 10, such as within engine compartment 18. Controller 56 may be a stand alone controller or may be incorporated into a controller used for other functions. To that end, it will be appreciated that the logic used for speed readiness indicator 50 may be accomplished with any desired combination of electronic hardware and/or software.

Visual indicator 54 is configured and positioned within operator's station 16 to provide an easy way for an operator to determine when saw 36 is at an operating speed. Visual indicator 54 is preferably positioned toward the front of operator's station 16 in an area of peripheral vision of the operator, and is configured so that the operator can know without directly observing visual indicator 54 that saw 36 is at an operating speed.

More particularly, referring to FIG. 3, visual indicator 54 can simply be one or more lights which are placed in an area of peripheral vision of the operator. In FIG. 3, two lights are shown for illustration but it will be understood that only a single light shown in FIG. 3 can also be used. For example, a single light 58 can have a first light color, preferably a green light, which is illuminated when saw 36 is within a predetermined range below a maximum operating speed. As a specific example, the maximum operating speed could be 2200 revolutions per minute (RPM) and the operating speed range at which light 58 is illuminated green could be between approximately 2000 to 2200 RPM. Light 58 preferably is a green light emitting diode (LED) using less power and having a longer life, but could also be an incandescent light with a green lens, etc.

In the event that a second light 60 is used in addition to light 58, then light 60 indicates that saw 36 is within one or more speed ranges below the operating speed range described above. For example, light 60 can have a second light color, preferably a yellow light, which is illuminated when saw 36 is below the operating speed range, at which point it is turned off and green light 58 is illuminated when saw 36 is within the operating speed range. Alternatively, light 60 could be a two color light, such as a red and yellow LED, and could be illuminated red when saw 36 is at or near a stopped rotational speed, and illuminated yellow at a faster speed which is still below the operating speed range.

In another embodiment, a single light 58 can be energized with a variable frequency indicating a readiness state of saw 36. For example, light 58 can be turned on an off with a frequency which increases as the speed of saw 36 increases, and continuously illuminated when saw 36 is within the operating speed range. That is, single light 58 can be energized with a lower frequency indicating a slower speed of saw 36, a higher frequency indicating a faster speed of saw 36, and a steady on condition indicating that saw 36 is within the operating speed range. This change again is recognizable within the peripheral vision of an operator without taking the eyes off of the task at hand.

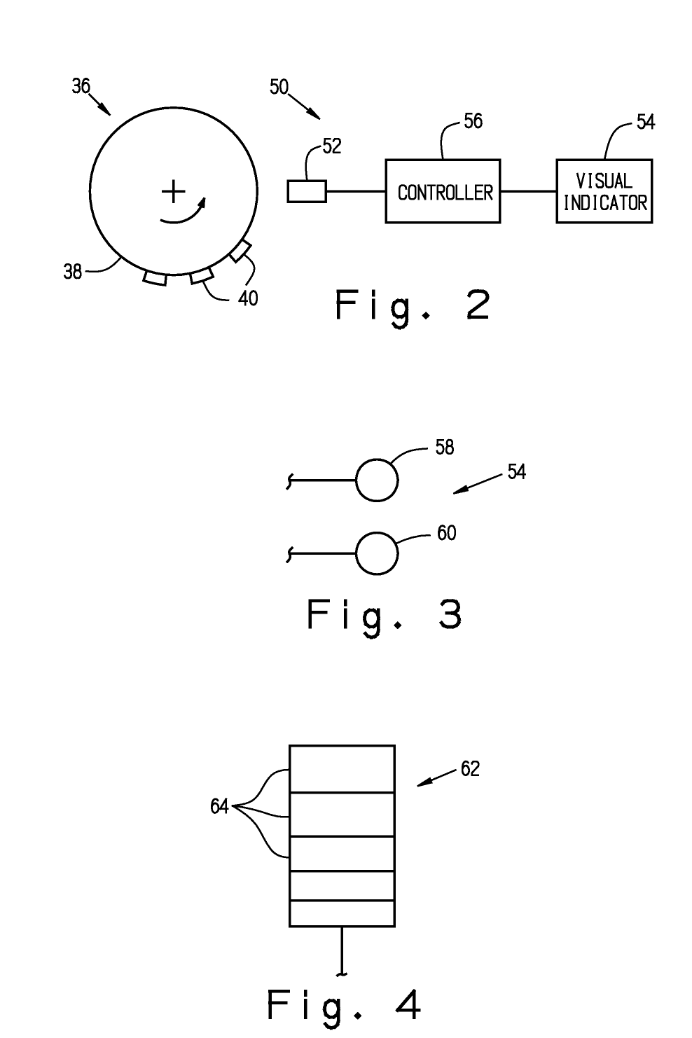

Referring now to FIG. 4, there is shown another embodiment of a visual indicator in the form of a light bar 62 with a plurality of vertically arranged, horizontally elongated lights 64. Preferably one or more top lights 64 are illuminated a first light color, such as green, to indicate that saw 36 is within an operating speed range, and one or more bottom lights 64 are illuminated a second light color, such as yellow or red, to indicate that saw 36 is operating below the operating speed range.

Having described the preferred embodiment, it will become apparent that various modifications can be made without departing from the scope of the invention as defined in the accompanying claims.

1. A speed readiness indicator for a felling saw in a forestry machine, comprising:
at least one sensor providing an indication of a rotational speed of a saw head;
a visual indicator; and
a controller coupled with each said sensor and said visual indicator, said controller receiving an input signal from each said sensor and actuating said visual indicator to indicate an approximate rotational speed of said saw head.

2. The speed readiness indicator of claim 1, wherein said visual indicator provides a variable indication of when said saw head is at an operating speed and below an operating speed.

3. The speed readiness indicator of claim 2, wherein said visual indicator outputs a first light color when said saw head is within a range surrounding said operating speed of said saw head, and a second light color when said saw head is below said range surrounding said operating speed of said saw head.

4. The speed readiness indicator of claim 3, wherein said first light color is green.

5. The speed readiness indicator of claim 4, wherein said second light color is one of yellow and red.

6. The speed readiness indicator of claim 4, wherein said visual indicator includes a first light providing said first light color and a second light providing said second light color.

7. The speed readiness indicator of claim 3, wherein said visual indicator includes a light bar with a plurality of vertically arranged lights.

8. The speed readiness indicator of claim 7, wherein said light bar includes at least one upper light providing a first light color and at least one lower light providing a second light color.

9. The speed readiness indicator of claim 8, wherein said first light color is green.

10. The speed readiness indicator of claim 9, wherein said second light color is one of yellow and red.

11. The speed readiness indicator of claim 2, wherein said visual indicator includes at least one light which is energized with a variable frequency, wherein a lower frequency indicates a slower rotational speed of said saw head, a faster frequency indicates a faster rotational speed of said saw head, and a steady on condition indicates that said saw head is within a range surrounding said operating speed.

12. The speed readiness indicator of claim 1, wherein said forestry machine includes an operators station, and said visual indicator is positioned within said operators station in an area of peripheral vision of an operator.

13. The speed readiness indicator of claim 1, wherein said at least one sensor includes a magnetic pick up sensor associated with said saw head.

14. A forestry machine, comprising:
a frame;
a felling saw carried by said frame, said felling saw including a saw head; and
a speed readiness indicator associated with said saw head, said speed readiness indicator including:
at least one sensor providing an indication of a rotational speed of said saw head;
a visual indicator; and
a controller coupled with each said sensor and said visual indicator, said controller receiving an input signal from each said sensor and actuating said visual indicator to indicate an approximate rotational speed of said saw head.

15. The forestry machine of claim 14, wherein said visual indicator provides a variable indication of when said saw head is at an operating speed and below an operating speed.

16. The forestry machine of claim 15, wherein said visual indicator outputs a first light color when said saw head is within a range surrounding said operating speed of said saw head, and a second light color when said saw head is below said range surrounding said operating speed of said saw head.

17. The forestry machine of claim 16, wherein said first light color is green.

18. The forestry machine of claim 17, wherein said second light color is one of yellow and red.

19. The forestry machine of claim 17, wherein said visual indicator includes a first light providing said first light color and a second light providing said second light color.

20. The forestry machine of claim 16, wherein said visual indicator includes a light bar with a plurality of vertically arranged lights.

21. The forestry machine of claim 20, wherein said light bar includes at least one upper light providing a first light color and at least one lower light providing a second light color.

22. The forestry machine of claim 21, wherein said first light color is green.

23. The forestry machine of claim 22, wherein said second light color is one of yellow and red.

24. The forestry machine of claim 15, wherein said visual indicator includes at least one light which is energized with a variable frequency, wherein a lower frequency indicates a slower rotational speed of said saw head, a faster frequency indicates a faster rotational speed of said saw head, and a steady on condition indicates that said saw head is within a range surrounding said operating speed.
